(19) United States
(12) Patent Application Publication
(10) Pub. No.: US 2008/0120803 A1
(43) Pub. Date: May 29, 2008

(54) Dual wheel caster

(76) Inventor: Frank Bryant, St. Louis, MO (US)

Correspondence Address: David H. Chervitz;Riezman Berger, P.C., 7th Floor, 7700 Bonhomme Avenue, St. Louis, MO, 63105, US

(21) Appl. No.: 11/604,531

(22) Filed: Nov. 27, 2006

(51) Int. Cl. B60B 33/00

(52) U.S. Cl. 16/47; 16/31 R; 16/18 A

(57) ABSTRACT

A dual wheel caster is disclosed that comprises a housing having a pair of opposed angled sides, a pair of wheels with one of the wheels being mounted to one of the angled sides and the other one of the wheels being mounted to the other one of the angled sides, and a step portion connected to the housing.

### BACKGROUND OF THE INVENTION

This invention relates to a dual wheel caster assembly and more particularly to a dual wheel caster having a pair of angled wheels.

Casters are used to support and move various equipment or structures such as furniture, chairs, and bed frames. The casters include one or two wheels and are employed to easily move or roll the structure to which the casters are mounted or attached. Generally, the casters have consisted of a central mounting member having an off-centered stem or a pintle extending up from the central mounting member. One or more wheels are mounted to the central mounting member. The stem is typically inserted into a socket plate that is fixed to a leg or other means of mounting the caster to the structure. In this manner, the caster may swivel to facilitate movement and maneuvering of the structure.

In a particular application, casters have been used on bed frames for many years. A bed frame typically is constructed of various structural members such as side rails and cross members that are connected to the side rails to form a rigid structure that supports a box spring and a mattress. The side rails and the cross members include leg portions that extend downwardly to elevate the structural members above the floor. Each of the leg portions have fitted or inserted therein a caster assembly to provide easy movement of the structural members, the box spring, and the mattress. The caster assembly is usually constructed having a rotatable roller to provide movement of the bed frame. The caster assembly also generally has a stem that fits into a corresponding connector in the leg portion. The caster assembly is capable of pivoting or swiveling through 360 degrees of motion about an axis of the stem.

Known caster assemblies associated with bed frames have a roller that only contacts the floor in a minimum amount of surface area. The roller is also offset or off-centered with respect to the leg portion and the downward force that acts through the stem of the caster assembly. One of the disadvantages with such caster assemblies is that the leg portion is apt to bend when the bed frame is being moved. This bending causes stress on the caster assembly and can lead to failure of the caster assembly or the leg portion. If the caster assembly or the leg portion breaks or fails then the entire bed frame is disabled.

The present invention is designed to obviate and overcome many of the disadvantages and shortcomings associated with prior casters. In particular, the present invention is a dual wheel caster that has angled wheels. Moreover, the present invention provides a dual wheel caster that divides the weight being applied to the wheels at two different load points. Further, the dual wheel caster of the present invention centers the weight being applied to the caster and reduces the stresses being applied to the structure to which the caster is mounted or attached. Due to the angle of the wheels, the dual wheel caster allows for rotation in the direction of the force applied to the dual wheel caster.

### SUMMARY OF THE INVENTION

In one form of the present invention, a dual wheel caster comprises a housing having a pair of opposed angled sides, a pair of wheels with one of the wheels being mounted to one of the angled sides and the other one of the wheels being mounted to the other one of the angled sides, and a stem portion connected to the housing.

In another form of the present invention, a dual wheel caster comprises a housing having a pair of opposed angled sides and a top side, a pair of wheels with one of the wheels being mounted to one of the angled sides and the other one of the wheels being mounted to the other one of the angled sides, and a stem portion centrally positioned on the top side and mounted to the top side of the housing.

In yet another form of the present invention, a dual wheel caster comprises a housing having a pair of opposed angled sides, a pair of wheels with each of the wheels being mounted to one of the opposed angled sides, and a stem portion mounted to the housing, the stem portion forming a center axis about which the caster is adapted to rotate.

In light of the foregoing comments, it will be recognized that a principal object of the present invention is to provide a dual wheel caster which is of simple construction and design and which can be easily employed with highly reliable results.

Another object of the present invention is to provide a dual wheel caster that divides the weight being applied to the caster into two different load points.

A further object of the present invention is to provide a dual wheel caster that is capable of being manufactured using commonly available components that are relatively inexpensive.

Another object of the present invention is to provide a dual wheel caster that is self tracking, rotates about a center axis, and swivels a full 360°.

A still further object of the present invention is to provide a dual wheel caster in which the wheels are angled.

Another object of the present invention is to provide a dual wheel caster that has increased strength, reliability, and durability.

A further object of the present invention is to provide a dual wheel caster that is not offset and does not bend or fracture.

A still further object of the present invention is to provide a dual wheel caster having a stem portion that is centrally positioned and is not offset.

These and other objects and advantages of the present invention will become apparent after considering the following detailed specification in conjunction with the accompanying drawings, wherein:

### BRIEF DESCRIPTION OF THE DRAWINGS

FIG. 1 is a perspective view of a preferred embodiment of a dual wheel caster constructed according to the present invention;

FIG. 2 is a side view of the dual wheel caster shown in FIG. 1;

FIG. 3 is a partial cross-sectional view of the dual wheel caster shown in FIG. 2 taken along the plane of line 3-3;

FIG. 4 is an exploded view of the dual wheel caster shown in FIG. 1;

FIG. 5 is a bottom view of the dual wheel caster shown in FIG. 1; and

FIG. 6 is a front view of the dual wheel caster shown in FIG. 1.

### DETAILED DESCRIPTION OF THE PREFERRED EMBODIMENTS

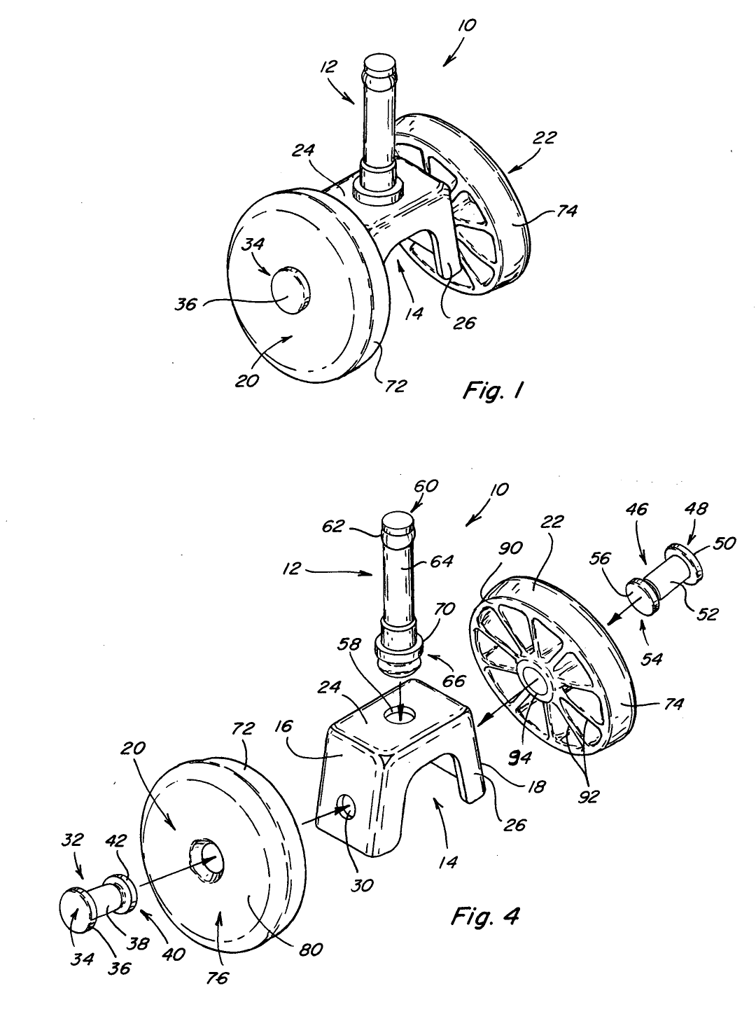

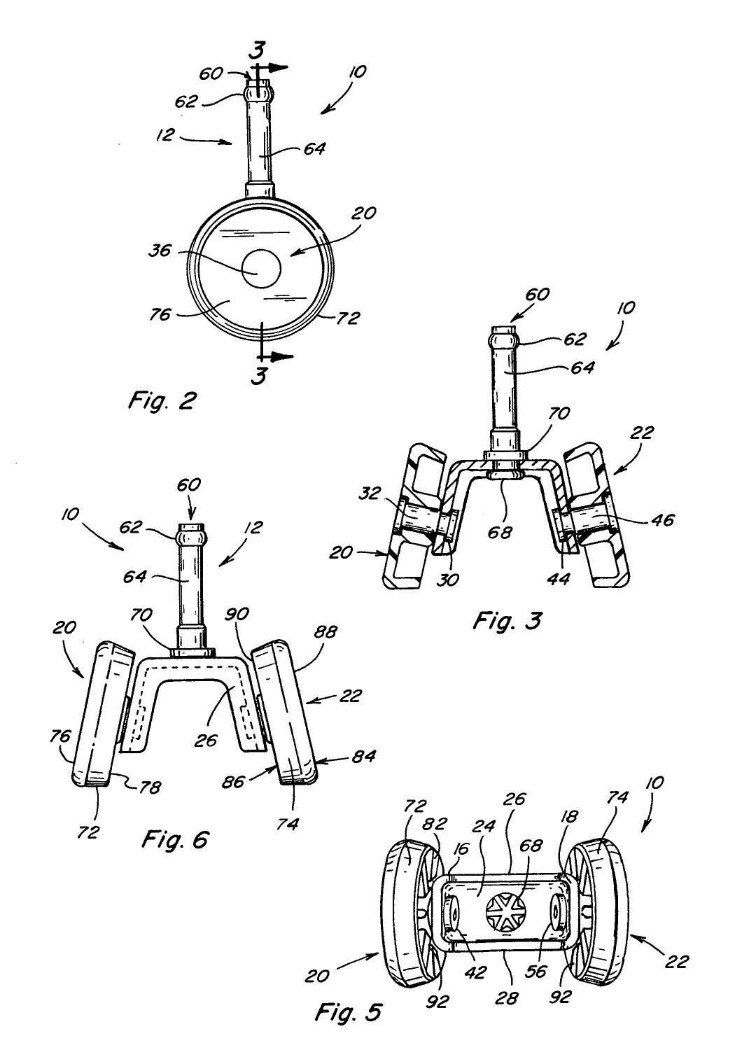

Referring now to the drawings, wherein like numbers refer to like items, number 10 identifies a preferred embodiment of a dual wheel caster constructed according to the present invention. With reference now to FIGS. 1-6, the dual wheel caster 10 is shown comprising a stem portion 12 mounted to a wheel housing or mount 14. The wheel housing 14 has a pair of opposed angled sides 16 and 18 and a pair of wheels 20 and 22 that are mounted to the sides 16 and 18, respectively. The housing 14 has a top 24 to which the stem 12 is mounted or connected. The stem 12 is centrally positioned in the top 24 of the housing 14. The stem portion 12 is adapted to fit in a socket member (not shown) that may be inserted into a frame portion (not shown) to allow the caster 10 to swivel or rotate a full 360°. The housing 14 has a front side 26 and a back side 28.

The side 16 has an opening or aperture 30 through which a pin or axle portion 32 is adapted to be inserted. The axle 32 has a first end 34 having a tab portion 36, an intermediate section 38, and a second end 40 having a tab portion 42. The first tab portion 36 is used to hold the wheel 20 in place along the axle 32 and the second tab portion 42 is used to hold the housing 14 in place along the axle 32. The side 18 has an opening or aperture 44 through which a pin or axle portion 46 is positioned. The axle 46 is constructed to have a first end 48 having a tab portion 50, an intermediate section 52, and a second end 54 having a tab portion 56. The first tab portion 50 is used to hold the wheel 22 in place along the axle 46 and the second tab portion 56 is employed to hold the housing 14 in place along the axle 46. Although the tab portions 36 and 50 are shown extending out of the respective wheels 20 and 22, it is possible to have the tap portions 36 and 50 captured within each of the wheels 20 and 22. It is also possible and contemplated to have other means or structure in place of the axle portions 32 and 46 such as screws, pins, nuts, shafts, bolts, or other known mounting devices that hold wheels to a body and allow the wheels to rotate.

The housing 14 also has a centrally located opening or aperture 58 formed in the top 24. The stem portion 12 comprises a top portion 60 having a shoulder 62, an intermediate portion 64, and a bottom portion 66. The shoulder 62 is adapted to fit within a socket member (not shown). For example, the socket member may be inserted into a leg portion of a bed frame assembly. In this manner, the caster 10 is able to rotate or swivel to be able to maneuver the bed frame. The bottom portion 66 of the stem 12 has a tab portion 68 that may be positioned through the opening 58 in the top 24 of the housing 14. The bottom portion 66 also has a shoulder 70 that rests against the top 24.

The sides 16 and 18 are angled or flared outwardly from the top 24. The wheels 20 and 22 are angled at the same angle as the opposed sides 16 and 18. The wheels 20 and 22 each have a tread 72 and 74, respectively, that place a portion of or the entire surface of each tread 72 and 74 in contact with the ground or a surface upon which the caster 10 is placed. The wheel 20 has an exterior side 76 and an interior side 78. The exterior side 76 has a diameter 80 and the interior side 78 has a diameter 82. The diameter 80 is greater than the diameter 82. The wheel 22 has an exterior side 84 and an interior side 86. The exterior side 84 has a diameter 88 and the interior side 86 has a diameter 90. The diameter 88 is greater than the diameter 90. Due to the angled sides 16 and 18 and the treads 72 and 74, a large surface area is presented to or in contact with the ground. The wheels 20 and 22 are spaced apart by the top 24 or the front side 26 or the rear side 28 of the housing 14. The spaced apart wheels 20 and 22 divide the weight being applied to the caster 10 into two different load points. Further, the caster 10 is always centered under the structure that the caster 10 is supporting. The caster 10 is capable of swiveling or rotating about a center axis with such axis being the stem portion 12.

Both of the wheels 20 and 22 may have a plurality of reinforcing ribs or members 92 radially extending out from a hub portion 94 much like spokes. Although the wheels 20 and 22 are shown as being hollow members, it is also possible for the wheels 20 and 22 to be solid in construction.

FIG. 5 illustrates a bottom view of the caster 10. The housing 14 is shown having the pair of opposed angled sides 16 and 18 extending downwardly from the top 24, the front side 26, and the rear side 28. The sides 16 and 18 are shown extending into the front side 26 and the rear side 28. In this manner the housing 14 is strengthened. The tab portion 68 of the stem 12 is shown mounted through the top 24 of the housing 14. The tab portion 42 of the axle portion 32 is positioned against the side 16 with the axle portion 32 being used to hold the wheel 20 against the side 16. Also, the tab portion 56 of the axle portion 46 is positioned against the side 18. Again, the axle portion 46 is used to hold or position the wheel 22 against the side 18.

Referring now to FIG. 6, a front view of the caster 10 is depicted. The dual wheel caster 10 comprises the stem portion 12 mounted to the wheel housing or mount 14. The wheel housing 14 has the pair of opposed angled sides 16 and 18, the top side 24, and the front side 26. The front side 26 is generally U-shaped in construction. However, if desired for strength or aesthetics, the front side 26 may be formed having a full side. Although not specifically depicted in this view, the rear side 28 is similarly constructed having a generally U-shape. Further, it is possible and contemplated that the housing 14 may be solid in construction. The sides 16 and 18 are angled outwardly from the top 24. The wheels 20 and 22, which are mounted to the sides 16 and 18, respectively, are also angled outwardly at the same or about the same angle as the sides 16 and 18.

From all that has been said, it will be clear that there has thus been shown and described herein a dual wheel caster which fulfills the various objects and advantages sought therefore. It will become apparent to those skilled in the art, however, that many changes, modifications, variations, and other uses and applications of the subject dual wheel caster are possible and contemplated. All changes, modifications, variations, and other uses and applications which do not depart from the spirit and scope of the invention are deemed to be covered by the invention, which is limited only by the claims which follow.

What is claimed is:

1. A dual wheel caster comprising:
a housing having a pair of opposed angled sides;
a pair of wheels with one of the wheels being mounted to one of the angled sides and the other one of the wheels being mounted to the other one of the angled sides; and
a stem portion connected to the housing.

2. The dual wheel caster of claim 1 wherein the pair of wheels each have a tread.

3. The dual wheel caster of claim 1 wherein the stem portion has an axis and the caster swivels about the axis.

4. The dual wheel caster of claim 1 wherein the pair of wheels each have an exterior surface having a first diameter and an interior surface having a second diameter wherein the first diameter is greater than the second diameter.

5. The dual wheel caster of claim 1 wherein the housing has a front side and the wheels are spaced apart from each other by the front side.

6. The dual wheel caster of claim 1 wherein the pair of wheels are angled at the same angle as the opposed sides.

7. A dual wheel caster comprising:
a housing having a pair of opposed angled sides and a top side;
a pair of wheels with one of the wheels being mounted to one of the angled sides and the other one of the wheels being mounted to the other one of the angled sides; and
a stem portion centrally positioned on the top side and mounted to the top side of the housing.

8. The dual wheel caster of claim 1 wherein the pair of wheels each have an exterior surface having a first diameter and an interior surface having a second diameter.

9. The dual wheel caster of claim 8 wherein the first diameter is greater than the second diameter.

10. The dual wheel caster of claim 7 wherein the pair of wheels each has a tread that is adapted to contact a surface.

11. The dual wheel caster of claim 7 wherein the pair of wheels are angled at the same angle as the opposed sides.

12. The dual wheel caster of claim 7 wherein the stem portion has an axis and the caster swivels about the axis.

13. The dual wheel caster of claim 7 wherein the housing has a front side and the wheels are spaced apart from each other by the front side.

14. A dual wheel caster comprising:
a housing having a pair of opposed angled sides;
a pair of wheels with each of the wheels being mounted to one of the opposed angle sides; and
a stem portion mounted to the housing, the stem portion forming a center axis about which the caster is adapted to rotate.

15. The dual wheel caster of claim 14 wherein the pair of wheels each has a tread that is adapted to contact a surface.

16. The dual wheel caster of claim 14 wherein the pair of wheels each have an exterior surface having a first diameter and an interior surface having a second diameter.

17. A dual wheel caster of claim 16 wherein the housing has a front side and the wheels are spaced apart from each other by the front side.

18. The dual wheel caster of claim 14 wherein the wheels are separated from each other to divide the weight being applied to the caster into two different load points.

19. The dual wheel caster of claim 14 wherein the pair of wheels are angled at the same angle as the opposed sides.

20. The dual wheel caster of claim 14 wherein the caster swivels about the center axis of the stem portion.
